(19) United States
(12) Patent Application Publication
(10) Pub. No.: US 2026/0016423 A1
(43) Pub. Date: Jan. 15, 2026

(54) HIGH-SPEED THREE-DIMENSIONAL X-RAY IMAGING APPARATUS AND METHOD FOR OBTAINING OF THREE-DIMENSIONAL X-RAY IMAGE USING THE SAME

(71) Applicant: Korea Advanced Institute of Science and Technology, Daejeon (KR)

(72) Inventors: Sung Oh CHO, Daejeon (KR); Heonyong JEONG, Daejeon (KR); JaeYoung IM, Daejeon (KR)

(21) Appl. No.: 19/253,362

(22) Filed: Jun. 27, 2025

(30) Foreign Application Priority Data
Jul. 9, 2024 (KR) 10-2024-0090597
Aug. 30, 2024 (KR) 10-2024-0117599

(51) Int. Cl. G01N 23/04

(52) U.S. Cl. CPC G01N 23/04; G01N 2223/401; G01N 2223/505

(57) ABSTRACT

The present invention relates to a high-speed three-dimensional X-ray imaging apparatus and a method for obtaining a three-dimensional X-ray image using the apparatus, the apparatus comprises a two-dimensional image acquisition part for acquiring multiple 2D X-ray images of an object to be inspected by varying the relative position between the X-ray source and the object so that X-rays are projected onto the object from various angles, and a three-dimensional image acquisition part acquiring a 3D X-ray image from a plurality of 2D X-ray images obtained by the two-dimensional image acquisition a 3D part using reconstruction algorithm.

### BACKGROUND OF THE INVENTION

### 1. Field of the Invention

The present invention relates to a high-speed three-dimensional X-ray imaging apparatus and a method for obtaining a three-dimensional X-ray image using the same.

### 2. Description of the Related Art

As the secondary battery and semiconductor markets grow, the importance of defect inspection systems for quality improvement is increasing, and the demand for three-dimensional inspection technology, which provides richer information than two-dimensional inspection, is increasing. In particular, in the secondary battery, semiconductor, and display industries, it is considered an essential technology for inspecting the processing status after the micro-processing of optical application components.

In general, 3D measurement technology in the semiconductor and display industries is required to be non-destructive, meaning it does not damage the inspection target, and to have a short measurement time to match the fast production speed.

Currently, the inspection methods for micro-machined parts have formed various technical fields according to their principles. Among the inspection methods, white light interference, moiré interference, and confocal microscopy, which irradiate a target with white light or light of a specific wavelength and detect and analyze the light reflected from the target, measure only the surface appearances of a micro-machined part. On the other hand, the method of using an X-ray micro CT device that utilizes X-rays that have the property of penetrating objects has the advantage of being able to measure the three-dimensional appearance and internal shape of the object in detail by placing the object to be measured on a rotating stage and observing the X-rays that pass through the object.

Meanwhile, in the X-ray generator, the electrons generated by the electron gun are accelerated toward the target by the potential difference between the cathode and anode, and are focused by a focusing lens placed along their path. The spot where these focused electrons strike the target is called the focal spot, whose diameter is called the focal spot size.

Conventional X-ray micro-CT devices use geometric magnification to obtain high-resolution images. FIG. 3 is a diagram illustrating the geometric magnification method of the conventional X-ray imaging device. Referring to FIG. 3, the geometric magnification method utilizes the spreading of X-rays to form a magnified transmission image of the object being inspected on a detector. When the distance from the X-ray source (X-ray tube) to the detector (Source to Detector Distance, SDD) is fixed, the shorter the distance from the X-ray source to the object (Source to Object Distance, SOD) the longer the distance from the object to the detector (Object to Detector Distance, ODD) becomes, the more the transmission image of the object is magnified, allowing for a higher resolution image in micrometers to be obtained. At this time, the equation for the magnification (M) is as follows.

$$Magnification ( M ) = \frac{ODD + SOD}{SOD} \qquad 〈 Equation 1 〉$$

This geometric magnification method analyzes the microstructure by magnifying the transmission image by adjusting the values of SOD and ODD as described above.

However, this geometric magnification method is highly sensitive to the X-ray focal spot size. Consequently, a larger focal spot size increases the blur at the detector according to the similar-triangles relationship. Equation 2 gives the blur size, and Equation 3 gives the resolution.

$$Blurring = \frac{ODD}{SOD} \times Focal Spot Size ( σ ) \qquad 〈 Equation 2 〉$$

$$Resolution = \frac{σ}{2} \times \frac{( M - 1 )}{M} \qquad 〈 Equation 3 〉$$

For this reason, a micro-focus X-ray tube with a focal spot size of 10 μm or less must be used to obtain a resolution of several μm images.

Meanwhile, the present inventors have disclosed a two-dimensional X-ray imaging device capable of inspecting defects in an inspection target over a wider area by obtaining X-ray images with a micrometer resolution by magnifying or demagnifying the visible light generated by the interaction of X-rays and a scintillator with an optical lens rather than a geometric magnification, and specifically, a device capable of obtaining an internal image of a semiconductor by reducing the X-ray focal size to 5 μm or less and magnifying it more than 200-fold using a micro-focus X-ray tube as an X-ray source (Korean Patent No. 10-2142488).

X-ray devices that employ micro-focus X-ray tubes can indeed achieve high-resolution imaging, but when the electron-beam output is increased, the beam is concentrated into a focal spot of 10 μm or less; the resulting local heat causes the target to melt. For this reason, increasing the output (current×voltage) of the electron beam is limited. Accordingly, conventional X-ray imaging devices using micro-focus X-ray tubes have the disadvantage that high-resolution X-ray images can only be obtained with low power, specifically 99 W or less, which requires a very long time to acquire images.

Meanwhile, 3D images are used more than 2D images for accurate analysis of structures. The method for obtaining a 3D X-ray image is to reconstruct multiple (>1000) 2D images acquired from various angles using an algorithm. To acquire multiple 2D images from different angles, rotate the object to be examined or rotate the X-ray source and the detector.

A commercialized micro-CT for microstructural analysis utilizes a micro-focus X-ray tube to acquire each 2D image. However, as mentioned above, due to the output limit of the micro-focus X-ray tube, it takes a long time to obtain a single image, and for this reason, there is a problem that it usually takes a very long time, more than 30 minutes, to acquire more than 800 2D images for 3D reconstruction.

While researching a method for obtaining high-resolution 3D X-ray images at high speed, the present inventors found that by obtaining images from X-rays by contacting the detector with the object to be detected, rather than by a geometric magnification method, the SOD to ODD ratio can be very small, minimizing the effect of blurring caused by the focal spot size according to Equation 2 above. Accordingly, the present inventors have developed a high-speed three-dimensional X-ray imaging system and a method for obtaining a three-dimensional X-ray image using the same that can acquire high-resolution 2D X-ray images in a very short time by using an apparatus that can obtain high-resolution 2D X-ray images without using a micro-focus X-ray tube to reduce the focal spot size to micro-meters but by using an X-ray tube with high power of 100 W or more, and to acquire 3D images using a 3D reconstruction algorithm, and have completed the present invention.

### SUMMARY OF THE INVENTION

It is an object of the present invention to provide a high-speed three-dimensional X-ray imaging system and a method for obtaining a three-dimensional X-ray image using the same.

To achieve the above object, in an aspect of the present invention, the present invention provides a high-speed three-dimensional X-ray imaging system comprising the following parts:
a two-dimensional image acquisition part for acquiring multiple 2D X-ray images of an object to be inspected by varying the position between the X-ray source and the object so that X-rays are projected onto the object from various angles using a two-dimensional X-ray imaging apparatus comprising an X-ray source for irradiating the object with high-power X-rays of 100 to 100,000 watts, and a detector in contact with the object and detecting 2D X-ray images from X-rays transmitted through the object; and
a three-dimensional image acquisition part acquiring a 3D X-ray image from a plurality of 2D X-ray images obtained by the two-dimensional image acquisition part using a 3D reconstruction algorithm.

The two-dimensional X-ray imaging apparatus can prevent blurring caused by the focal spot size of the X-ray source by positioning the inspection object to contact with the detector.

The high-speed three-dimensional X-ray imaging apparatus can obtain 3D X-ray images with a resolution of 1 to 100 μm within 60 seconds.

The two-dimensional X-ray imaging apparatus may include at least one of an X-ray source moving means for moving the X-ray source and an object moving means for moving the object as a moving means for varying the position between the X-ray source and the object to be inspected.

The detector may be either (i) a direct detector that two-dimensional X-ray images from X-rays transmitted through the inspection object or (ii) an indirect detector comprising: (a) a scintillator that converts the transmitted X-rays into visible light; (b) an optical lens that magnifies or demagnifies the visible light with a magnification factor different from 1×; and (c) a visible-light detector that senses the converted light.

The high-speed three-dimensional X-ray imaging apparatus may further comprise an image-output unit that outputs the three-dimensional X-ray image.

In another aspect of the present invention, the present invention provides a method for obtaining a three-dimensional X-ray image using the high-speed three-dimensional X-ray imaging system comprising the following steps:
a two-dimensional X-ray image acquisition step for acquiring multiple 2D X-ray images of an object to be inspected by varying the position between the X-ray source and the object so that X-rays are projected onto the object from various angles using a two-dimensional X-ray imaging apparatus comprising an X-ray source for irradiating the object with high-power X-rays of 100 to 100,000 watts, and a detector positioned to be in contact with the object and detecting 2D X-ray images from X-rays transmitted through the object; and
a three-dimensional X-ray image acquisition step for acquiring a 3D X-ray image from a plurality of 2D X-ray images obtained in the two-dimensional X-ray image acquisition step using a 3D reconstruction algorithm.

The two-dimensional X-ray imaging apparatus can prevent blurring caused by the focal spot size of the X-ray source by positioning the inspection object to contact with the scintillator.

The method for obtaining a three-dimensional X-ray image can obtain 3D X-ray images with a resolution of 1 to 100 μm within 60 seconds.

In the above two-dimensional X-ray imaging apparatus, the detector is an indirect detector comprising a scintillator that detects X-rays transmitted through the inspection object and generates visible light, an optical lens configured to magnify, demagnify, or relay the visible light with a magnification factor M in the range of about 0.01× to about 100×, inclusive of unity magnification (M=1×), and a visible light detector that detects the visible light.

In the two-dimensional X-ray image acquisition step, 2D X-ray images enlarged or reduced by 1 or more times can be obtained through the optical lens.

In addition, the high-speed method for obtaining a three-dimensional X-ray image may further include a step of outputting a three-dimensional X-ray image.

### Advantageous Effect

The present invention has the advantage of being able to obtain high-resolution X-ray images without focusing the focal spot size to several micrometers.

In addition, since the present invention does not require the use of a micro-focus X-ray tube, a high-power X-ray source of 100 W or more can be used, thereby having the advantage of being able to output high-resolution X-ray images at high speed.

Furthermore, the present invention has the advantage of being able to obtain a three-dimensional X-ray image in a very short time by reconstructing images using a three-dimensional reconstruction algorithm.

Accordingly, the present invention can improve the quality of production processes in cutting-edge industries (secondary batteries, semiconductors, etc.) by being used for 3D X-ray imaging that requires high-speed output of high-resolution 3D X-ray images. This can contribute to improving consumer confidence and safety in products, thereby strengthening the competitiveness of manufacturing and securing an edge in the global market.

The effects of the present invention are not limited to those mentioned above, and other effects not mentioned will be clearly understood by those skilled in the art from the description below.

### BRIEF DESCRIPTION OF THE DRAWINGS

FIG. 1 is a schematic diagram illustrating the two-dimensional X-ray imaging apparatus according to one embodiment.

FIG. 2 is a diagram illustrating the degree of blurring resulting from the focal spot size of the X-ray source as it varies with the geometric magnification of the object according to one embodiment.

FIG. 3 is a diagram illustrating the geometric magnification method of a conventional X-ray imaging apparatus.

FIG. 4 is a schematic diagram illustrating the X-ray imaging apparatus that obtains a three-dimensional image by rotating an inspection object to vary the position between an X-ray source and the inspection object.

FIG. 5 is a schematic diagram illustrating the high-speed X-ray imaging apparatus that varies the position between an X-ray source and an inspection object by moving the X-ray source in a linear motion (left), by moving the object in an isocentric motion that rotates about the center of rotation (center), or by moving the object in a circular motion with the axis of rotation substantially perpendicular to the stage or in any direction (right).

### DESCRIPTION OF THE PREFERRED EMBODIMENTS

Hereinafter, embodiments of the present invention will be described in detail with reference to the drawings. However, the present invention is not limited to the specific embodiments below, and it should be understood that it includes all modifications, equivalents, and substitutes included in the spirit and technical scope of the present invention.

The terms used in this specification are only used to describe specific embodiments and the present invention is not limited thereto.

Throughout the specification and claims, the terms “first” and “second” are used herein for distinguishing purposes only and are not intended to indicate or connote any order or priority in any way. Although these may be used to describe various components, components are not limited by these terms. For example, without departing from the scope of the present invention, the first component could be named the second component, and similarly, the second component could also be named the first component.

Also, when a component is referred to as being “connected” or “conjugated” to another component, it should be understood that it may be directly connected or conjugated into that other component, but there may be other components in between. On the other hand, when a component is said to be “directly connected” or “directly conjugated” to another component, it should be understood that there are no other components in between.

Further, the terms “include” or “have” and the like are intended to designate the presence of the features, actions, components, parts, or numbers, steps, combinations thereof described in the specification and do not exclude the possibility of the presence or addition of one or more other features, numbers, steps, actions, components, parts, or combinations thereof.

In addition, unless otherwise defined, all terms used in this specification, including technical or scientific terms, have the same meaning as commonly understood by one of ordinary skill in the art to which the present invention belongs. The terms defined in commonly used dictionaries should be interpreted as having meanings consistent with their meaning in the context of the relevant technology and will not be interpreted in an idealized or overly formal sense unless expressly defined otherwise herein.

In an aspect of the present invention, the present invention provides a high-speed three-dimensional X-ray imaging system comprising the following parts:
a two-dimensional image acquisition part for acquiring multiple 2D X-ray images of an object to be inspected by varying the position between the X-ray source and the object so that X-rays are projected onto the object from various angles using a two-dimensional X-ray imaging apparatus comprising an X-ray source for irradiating the object with high-power X-rays of 100 to 100,000 watts, and a detector positioned to be in contact with the object and detecting 2D X-ray images from X-rays transmitted through the object; and
a three-dimensional image acquisition part acquiring a 3D X-ray image from a plurality of 2D X-ray images obtained by the two-dimensional image acquisition part using a 3D reconstruction algorithm.

Hereinafter, the high-speed three-dimensional X-ray imaging system according to one embodiment will be described in detail with reference to the drawings.

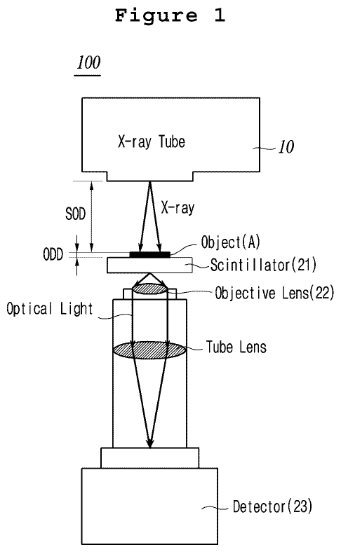

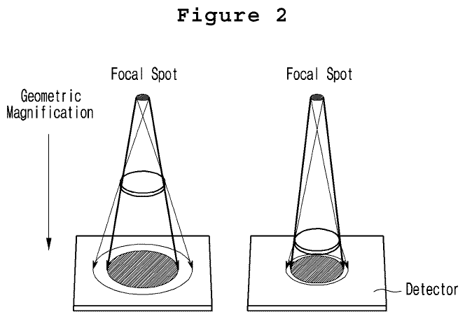

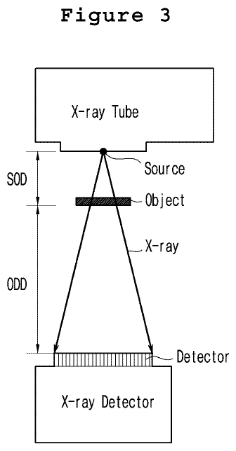

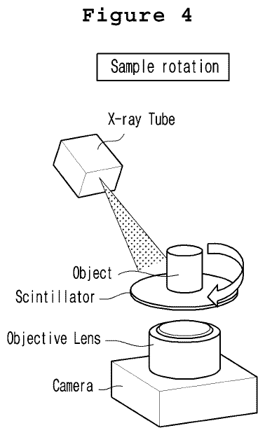

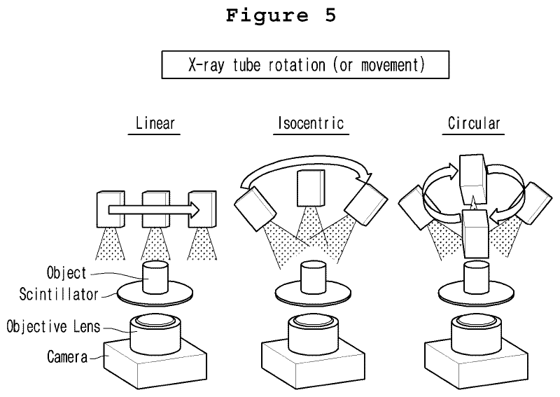

FIG. 1 is a diagram illustrating the two-dimensional X-ray imaging apparatus according to one embodiment, FIG. 2 is a diagram illustrating the degree of blurring resulting from the focal spot size of the X-ray source as it varies with the geometric magnification of the object according to one embodiment, FIG. 3 is a diagram illustrating the geometric magnification method of a conventional X-ray imaging apparatus, FIG. 4 is a schematic diagram illustrating the X-ray imaging apparatus in which a stage rotates to vary the position between an X-ray source and an inspection object, and FIG. 5 is a schematic diagram illustrating the high-speed X-ray imaging apparatus that varies the position between an X-ray source and an inspection object by moving the X-ray source in a linear motion (left), by moving the object in an isocentric motion that rotates about the center of rotation (center), or by moving the object in a circular motion with the axis of rotation substantially perpendicular to the stage or in any direction (right).

The high-speed three-dimensional X-ray imaging system according to one embodiment includes a two-dimensional image acquisition part for acquiring multiple 2D X-ray images of an object to be inspected by varying the position between the X-ray source and the object so that X-rays are projected onto the object from various angles using a two-dimensional X-ray imaging apparatus (100) comprising an X-ray source (10) for irradiating the object with high-power X-rays of 100 to 100,000 watts, and a detector positioned to be in contact with the object and detecting 2D X-ray images from X-rays transmitted through the object; and

The two-dimensional X-ray imaging apparatus (100) may include an X-ray tube as an X-ray source (10) for generating X-rays, and may preferably include a high-power X-ray tube of 100 W or more, 500 W or more, 1000 W or more, 10,000 W or more, or 100 W to 100,000 W.

The two-dimensional X-ray imaging apparatus (100) can obtain high-resolution two-dimensional X-ray images having a resolution of 30 μm or less, preferably 0.1 to 100 μm, more preferably 0.1 to 30 μm, and more preferably 1 to 30 μm, even if the electron beam focal spot size is formed to be 100 μm or more, preferably 100 to 100,000 μm, to generate X-rays.

Accordingly, since the two-dimensional X-ray imaging apparatus (100) uses a high-power X-ray tube of 100 W or more, preferably 100 to 100,000 W, rather than a micro-focus X-ray tube, it has the advantage of being able to quickly generate high-resolution two-dimensional X-ray images having a resolution of 0.1 to 100 μm, preferably 0.1 to 30 μm.

The two-dimensional X-ray imaging apparatus (100) is characterized by including a detector that detects X-rays that penetrate the inspection object and reach the apparatus by having at least one surface in contact with the inspection object and detects two-dimensional X-ray images.

The detector may include either a direct detector for detecting 2D X-ray images by detecting X-rays transmitted through the inspection object; and an indirect detector comprising a scintillator (21) that detects X-rays transmitted through the inspection object and generates visible light, an optical lens that configured to magnify, demagnify, or relay the visible light with a magnification factor M in the range of about 0.01× to about 100×, inclusive of unity magnification (M=1×), and a visible light detector (23) that detects the visible light.

Herein, the indirect detector may further comprise an optical lens (22) that magnifies or demagnifies, or relay the visible light generated from the scintillator (21) by one or more times. Accordingly, the direct detector can detect X-rays that have passed through the inspection object without magnification or reduction to detect two-dimensional X-ray images, whereas the indirect detector can magnify or reduce X-ray images by a magnification/reduction method using the optical lens (22). FIG. 1 shows an example including the indirect detector.

The two-dimensional X-ray imaging apparatus (100) can prevent blurring caused by the focal spot size of the X-ray source by positioning the inspection object (A) to contact with the detector.

Specifically, the conventional X-ray 3D imaging apparatus using a geometric magnification method includes an anode configuration for concentrating the focus to reduce blurring caused by the focal size that occurs in geometric magnification, but in this case, there is a limit to increasing the output due to durability issues of the anode. In addition, if the output is low, it takes a long time to penetrate materials such as metal to get a good-quality transmission image.

However, the two-dimensional X-ray imaging apparatus (100) is configured to contact the inspection object and the detector (or scintillator), thereby making the distance between the object and the detector (or scintillator) (ODD) very small compared to the distance between the X-ray source and the object (SOD), thereby minimizing the effect of blurring caused by the focal size. In addition, since the image enlargement is conducted using an optical lens rather than a geometric enlargement method, the problem of blurring caused by the focal spot size in the enlarged image is minimized to a negligible level, so that a high-resolution X-ray image of less than 30 μm can be obtained even at a large focal spot size of 100 μm or more.

That is, the high-speed X-ray imaging apparatus (100) according to one embodiment has the advantage of having a significantly higher resolution at the same electron beam focal spot size compared to a conventional apparatus, and thus has the advantage of not having to use a micro-focus X-ray tube and the advantage of being able to increase the output power of the electron beam, thereby enabling high-speed output of X-ray images.

In the indirect detector, the scintillator (21) may detect X-rays projected from the X-ray source (10). The scintillator (21) can emit, form, or generate light when it detects the X-rays. At least one side of the scintillator (21) can contact the inspection object (A). The scintillator (21) can receive X-rays that have been irradiated from the X-ray source (10) and passed through the object (A), by the surface that comes into contact with the object (A). The scintillator (21) may include a fluorescent material that emits light when struck by radiation. The scintillator (21) may include an inorganic scintillator or an organic scintillator. The inorganic scintillator may include NaI(Tl), ZnS(Ag), CsI(Tl), LiI(Tl), GAGG(Ce), etc. The scintillator (21) may have a larger area than the inspection object (A). The scintillator (21) can detect X-rays generated from the X-ray source (10) and direct the generated light to the visible light detector (23).

The indirect detector may comprise an optical lens (22) disposed between the scintillator (21) and the visible light detector (23).

The optical lens (22) can form an image using light generated from the scintillator (21). The optical lens (22) can magnify or reduce the image to a size of 1 or more, preferably above 1.

The optical lens (22) may include an objective lens and an ocular lens. The optical lens (40) can create a first magnified real image through light obtained from the scintillator (21) through an objective lens with a short focal length, and magnify this again through an ocular lens.

In the optical lens (22), when the light generated by the scintillator (21) is incident outside the focal point of the objective lens, the objective lens forms a magnified real image. This first magnified image then serves as the object for the ocular lens. The first magnified image is difficult to see clearly because it is focused inside the distance of distinct vision, so a convex lens is used to send the image backwards so that a clear image can be seen. By shifting the intermediate image to the near point and projecting it farther back through the ocular lens, a clearly visible magnified virtual image is obtained.

The optical lens (22) magnifies an object so that it can be accurately observed. The optical lens (22) can magnify an image and maintain the resolution of the image. The optical lens (22) may utilize visible light having a wavelength range of about 400 nm to 700 nm. When using blue light with a short wavelength of 400 nm in this range of light, the resolution is 200 nm, and the maximum magnification can be about 1,000 times.

The optical lens (22) may not be used if magnification for the light generated by the scintillator is not required.

The high-speed three-dimensional X-ray imaging system according to one f the present invention can obtain multiple 2D X-ray images of an object to be inspected by varying the position between the X-ray source (10) and the object so that X-rays are projected onto the object from various angles using the two-dimensional X-ray imaging apparatus (100).

The two-dimensional image acquisition part may include at least one of an X-ray source moving means for moving the X-ray source and an object moving means for moving the object as a moving means for varying the position between the X-ray source and the object to be inspected.

At this time, the X-ray source moving means can move the X-ray source in a straight line, rotational, spiral, or zig-zag manner, but is not limited thereto, and can move the X-ray source in various ways to vary the position between the X-ray source and the object to be inspected for three-dimensional reconstruction.

As shown in FIG. 4, the two-dimensional image acquisition part can vary the position between the X-ray source (10) and the inspection object (A) by rotating the inspection object, thereby obtaining a three-dimensional image.

In addition, as shown in FIG. 5, the two-dimensional image acquisition part can vary the position between the X-ray source and the inspection object by moving the X-ray source linearly (left), moving it isocentrically (center) around the inspection object as the center of rotation, or moving it circularly (right) around a direction substantially perpendicular to the stage or an arbitrary direction as the axis of rotation, or can additionally move the X-ray source spirally or zig-zag, thereby allowing X-rays to be projected onto the inspection object from various angles.

The high-speed three-dimensional X-ray imaging system according to one embodiment of the present invention includes a three-dimensional image acquisition part acquiring a 3D X-ray image from a plurality of 2D X-ray images obtained by the two-dimensional image acquisition part using a 3D reconstruction algorithm.

The high-speed three-dimensional X-ray imaging apparatus according to one embodiment of the present invention is capable of acquiring a three-dimensional X-ray image at high speed through the three-dimensional X-ray acquisition part configuration, and more specifically, can generate a 3D X-ray image with 10 to 2000 2D X-ray images of the detection object through the three-dimensional reconstruction algorithm, so that a 3D X-ray image can be obtained within 60 seconds, preferably within 1 to 60 seconds, within 50 seconds, within 40 seconds, or within 30 seconds.

At this time, the three-dimensional reconstruction algorithm may use one of the backprojection, filtered backprojection, iterative reconstruction, and deep-learning reconstruction techniques.

The high-speed three-dimensional X-ray imaging apparatus according to one embodiment of the present invention has the advantage of being able to acquire a three-dimensional X-ray image having a resolution of 0.1 to 100 μm, preferably 0.1 to 30 μm, within 60 seconds, preferably within 1 to 60 seconds, within 50 seconds, within 40 seconds, or within 30 seconds, through a two-dimensional X-ray image acquisition part configuration that generates X-rays at high power of 100 to 100,000 W and magnifies the visible light generated by the reaction of the X-rays with the scintillator, and a three-dimensional image acquisition part configuration that acquires a 3D X-ray image using a three-dimensional reconstruction algorithm.

In addition, the high-speed three-dimensional X-ray imaging system may further comprise an image output part that outputs a three-dimensional X-ray image.

At this time, the image output part may include various output devices capable of outputting a three-dimensional image, for example, a displayer.

In another aspect of the present invention, the present invention provides a method for obtaining a three-dimensional X-ray image using the high-speed three-dimensional X-ray imaging apparatus comprising the following steps:
a two-dimensional X-ray image acquisition step for acquiring multiple 2D X-ray images of an object to be inspected by varying the position between the X-ray source and the object so that X-rays are projected onto the object from various angles using a two-dimensional X-ray imaging apparatus comprising an X-ray source for generating X-rays by impinging an accelerated electron beam onto a target, and irradiating said X-rays onto an object to be inspected, a scintillator positioned in contact with the object and generating visible light by detecting X-rays passing through the object, and a detector that receives the visible light generated by the scintillator and detects two-dimensional X-ray images; and
a three-dimensional X-ray image acquisition step for acquiring a 3D X-ray image from a plurality of 2D X-ray images obtained in the two-dimensional X-ray image acquisition step using a 3D reconstruction algorithm.

Hereinafter, a method for obtaining a high-speed three-dimensional X-ray image according to one embodiment of the present invention is described in detail step by step.

The method for obtaining a high-speed three-dimensional X-ray image according to one embodiment of the present invention includes a two-dimensional X-ray image acquisition step.

The above step is a step performed through a two-dimensional X-ray image acquisition part of the high-speed three-dimensional X-ray imaging system.

The step of acquiring the two-dimensional X-ray image includes projecting the X-rays generated by the X-ray source onto the object to be inspected.

The above step is characterized by being able to obtain X-ray images at high speed as the X-ray source generates high-power X-rays of 100 to 100,000 W.

In addition, the two-dimensional X-ray image acquisition step may be a step of detecting a two-dimensional X-ray image by a detector that detects the X-rays penetrating the object and reaching the detector.

At this time, the detector may be a direct detector for detecting 2D X-ray images by detecting X-rays transmitted through the inspection object or an indirect detector comprising a scintillator that detects X-rays transmitted through the inspection object and generates visible light, an optical lens configured to magnify, demagnify, or relay the visible light with a magnification factor M in the range of about 0.01× to about 100×, inclusive of unity magnification (M=1×), and a visible light detector that detects the visible light.

Herein, the indirect detector may further comprise an optical lens (22) that magnifies or demagnifies, or relay the visible light generated from the scintillator (21) by one or more times. Accordingly, the direct detector can detect X-rays that have passed through the inspection object without magnification or reduction to detect two-dimensional X-ray images, whereas the indirect detector can magnify or reduce X-ray images by a magnification/reduction method using the optical lens (22).

In the above step, when using an indirect detector, the step may include a step in which a scintillator (21) detects X-rays and generates visible light, and the scintillator (21) is arranged to be in one side contact with the object (A), and receives X-rays projected from the X-ray source (10) through the one side and generates visible light.

In addition, in the above step, when using an indirect detector, the step may further include a step of magnifying or reducing the visible light by 1 or more times through the optical lens (22).

The above step is a step of magnifying or reducing visible light by more than one time through an optical lens (22). The optical lens (22) may include an objective lens and an ocular lens, and may generate a first magnified real image through light obtained from the light detection unit through an objective lens with a short focal length, and magnify this again through an ocular lens.

In the optical lens (22), when the light generated by the scintillator (21) is input outside the focus of the objective lens, a real image magnified by the objective lens can be created. The first magnified image acts as an object when viewed from the perspective of the ocular lens. The first magnified image is difficult to see clearly because it is focused inside the distance of distinct vision, so a convex lens is used to send the image backwards so that a clear image can be seen. By pulling the image created by the light generated from the scintillator (21) into the distance of distinct vision and projecting the magnified image backwards by an ocular lens (convex lens), the magnified virtual image can be seen clearly.

The optical lens (22) magnifies an object so that it can be accurately observed. The optical lens (22) can magnify an image and maintain the resolution of the image. The optical lens (22) may utilize visible light having a wavelength range of about 400 nm to 700 nm. When using blue light with a short wavelength of 400 nm in this range of light, the resolution is 200 nm, and the maximum magnification can be about 1,000 times.

The two-dimensional X-ray image acquisition step may be a step of detecting two-dimensional X-ray images while varying the position between the X-ray source and the object to be inspected.

The above two-dimensional X-ray image acquisition step has the advantage of being able to acquire two-dimensional X-ray images at high speed by rotating the object (sample) or rotating the X-ray source and/or detector.

The method for obtaining a high-speed three-dimensional X-ray image according to one embodiment of the present invention includes a three-dimensional X-ray image acquisition step.

The above step is a step performed through a three-dimensional X-ray image acquisition part of the high-speed three-dimensional X-ray imaging apparatus.

The above step is a step of obtaining a three-dimensional X-ray image from a plurality of two-dimensional X-ray images obtained in the two-dimensional X-ray image acquisition step using a three-dimensional reconstruction algorithm in the three-dimensional X-ray image acquisition step.

The method for obtaining a high-speed three-dimensional X-ray image according to one embodiment of the present invention is capable of acquiring a three-dimensional X-ray image at high speed through the three-dimensional X-ray step, acquisition and more specifically, can generate a 3D X-ray image with 10 to 2000 2D X-ray images of the detection object through the three-dimensional reconstruction algorithm, so that a 3D X-ray image can be obtained within 60 seconds, preferably within 1 to 60 seconds, within 50 seconds, within 40 seconds, or within 30 seconds.

At this time, the three-dimensional reconstruction algorithm may use one of the backprojection, filtered backprojection, iterative reconstruction, and deep-learning reconstruction techniques.

The method for obtaining a high-speed three-dimensional X-ray image according to one embodiment of the present invention has the advantage of being able to acquire a three-dimensional X-ray image having a resolution of 0.1 to 100 μm within 60 seconds, preferably within 1 to 60 seconds, within 50 seconds, within 40 seconds, or within 30 seconds, through a two-dimensional X-ray image acquisition part configuration that utilizes X-rays at high power of 100 to 100,000 W and acquires two-dimensional X-ray images by bringing the object and the detector into contact to prevent blurring caused by the focal spot size of the X-ray source, and a three-dimensional X-ray image acquisition part configuration that acquires a 3D X-ray image using a three-dimensional reconstruction algorithm.

### BRIEF DESCRIPTION OF THE MARK OF DRAWINGS

100: two-dimensional X-ray imaging apparatus
10: X-ray source
21: scintillator
22: optical lens
23: visible light detector

What is claimed is:

1. A high-speed three-dimensional X-ray imaging system comprising the following parts:
a two-dimensional image acquisition part for acquiring multiple 2D X-ray images of an object to be inspected by varying the relative position of the X-ray source and the object so that X-rays are projected onto the object from various angles using a two-dimensional X-ray imaging apparatus comprising an X-ray source having a power output of 100 to 100,000 watts, and a detector in contact with the object and detecting 2D X-ray images from X-rays transmitted through the object; and
a three-dimensional image acquisition part acquiring a 3D X-ray image from a plurality of 2D X-ray images obtained by the two-dimensional image acquisition part using a 3D reconstruction algorithm.

2. The high-speed three-dimensional X-ray imaging apparatus according to claim 1, wherein the two-dimensional X-ray imaging apparatus is positioned such that the inspection object is in contact with the detector to prevent blurring caused by the focal spot size of the X-ray source.

3. The high-speed three-dimensional X-ray imaging system according to claim 1, wherein the high-speed three-dimensional X-ray imaging apparatus acquires a three-dimensional X-ray image having a resolution of 0.1 to 100 μm within 60 seconds.

4. The high-speed three-dimensional X-ray imaging system according to claim 1, wherein the two-dimensional X-ray imaging apparatus includes at least one of an X-ray source moving means for moving the X-ray source and an object moving means for moving the object as a moving means for varying the position between the X-ray source and the inspection object.

5. The high-speed three-dimensional X-ray imaging system according to claim 1, wherein the detector includes either a direct detector for detecting 2D X-ray images by sensing X-rays transmitted through the inspection object or an indirect detector comprising a scintillator that detects X-rays transmitted through the inspection object and generates visible light, an optical lens configured to magnify, demagnify, or relay the visible light with a magnification factor M in the range of about 0.01× to about 100×, inclusive of unity magnification (M=1×), and a visible light detector that detects the visible light.

6. The high-speed three-dimensional X-ray imaging system according to claim 1, wherein the high-speed three-dimensional X-ray imaging apparatus further comprises an image-output unit that outputs a three-dimensional X-ray image.

7. A method for obtaining a three-dimensional X-ray image at high speed using the high-speed three-dimensional X-ray imaging system of claim 1 comprising the following steps:
a two-dimensional X-ray image acquisition step for acquiring multiple 2D X-ray images of an object to be inspected by varying the position between the X-ray source and the object so that X-rays are projected onto the object from various angles using a two-dimensional X-ray imaging apparatus comprising an X-ray source for irradiating the object with high-power X-rays of 100 to 100,000 watts, and a detector positioned to be in contact with the object and detecting 2D X-ray images from X-rays transmitted through the object; and
a three-dimensional X-ray image acquisition step for acquiring a 3D X-ray image from a plurality of 2D X-ray images obtained in the two-dimensional X-ray image acquisition step using a 3D reconstruction algorithm.

8. The method for obtaining a three-dimensional X-ray image at high speed according to claim 7, wherein the two-dimensional X-ray imaging apparatus is positioned such that the inspection object is in contact with the detector to prevent blurring caused by the focal spot size of the X-ray source.

9. The method for obtaining a three-dimensional X-ray image at high speed according to claim 7, wherein the method acquires a three-dimensional X-ray image having a resolution of 0.1 to 100 μm within 60 seconds.

10. The method for obtaining a three-dimensional X-ray image at high speed according to claim 7, wherein the detector of the two-dimensional X-ray imaging apparatus is an indirect detector comprising a scintillator that detects X-rays transmitted through the inspection object and generates visible light, an optical lens configured to magnify, demagnify, or relay the visible light with a magnification factor M in the range of about 0.01× to about 100×, inclusive of unity magnification (M=1×), and a visible light detector that detects the visible light; and wherein the two-dimensional X-ray image-acquisition step comprises obtaining a two-dimensional X-ray image having said magnification factor M as provided by the optical lens.

11. The method for obtaining a three-dimensional X-ray image at high speed according to claim 7, wherein the method further comprises a step of outputting a three-dimensional X-ray image.
